(19) United States
(12) Patent Application Publication
(10) Pub. No.: US 2022/0287310 A1
(43) Pub. Date: Sep. 15, 2022

(54) HYPOCHLOROUS ACID COMPOSITION AND APPLICATIONS THEREOF

(71) Applicant: White Factor International Limited, Tortola (VG)

(72) Inventors: Han-Po Wang, Taipei City (TW); Hsiang-En Tseng, New Taipei City (TW)

(21) Appl. No.: 17/230,125

(22) Filed: Apr. 14, 2021

(30) Foreign Application Priority Data
Mar. 11, 2021 (TW) 110108653

(51) Int. Cl. A01N 59/00; A01N 25/24

(52) U.S. Cl. CPC A01N 59/00; A01N 25/24

(57) ABSTRACT

The present application discloses a hypochlorous acid composition and applications thereof wherein the hypochlorous acid composition comprises fluorosilicate, hypochlorous acid, and hypochlorite, the hypochlorous acid composition sprayed is transformed to hypochlorous acid gels, and the hypochlorous acid gels deriving from the sprayed hypochlorous acid composition are evenly coated on an object for a long period of time without another medium for lower infection and contamination risks during usage of hypochlorous acid gels.

### FIELD OF THE INVENTION

The present application discloses a hypochlorous acid composition and applications thereof. More particularly, the hypochlorous acid composition sprayed is transformed to hypochlorous acid gels which are evenly coated on the surface of an object for a long period of time without a medium.

### DESCRIPTION OF THE PRIOR ART

The hypochlorous acid as an effective ingredient for the anti-microbial function is used to kill microbes such as viruses, bacteria, and fungi in a variety of environments but criticized for some drawbacks, for example, sterilization is adversely affected by a pH value which is optimal for disinfection between 4 and 7, difficult preservation, i.e., degradation of the hypochlorous acid contacting with oxygen, sunlight or heat, and poor compatibility, i.e., the hypochlorous acid is difficultly synthesized with other substances for the production of a new formulation. Accordingly, the application of the hypochlorous acid is limited.

Furthermore, another limitation of the liquid hypochlorous acid is its fluidity that causes drippings of hypochlorous acids adhering to an object or skin surface uneasily and transitorily. Comparatively, hypochlorous acid gels are satisfactory for better adhesion. However, hypochlorous acid gels squeezed out from a tube by a user troublesome and spread unevenly should be applied on a surface to be disinfected by hands or another medium and give rise to contact pollution easily. In addition, a sprayer may be jammed by a sticky hypochlorous acid gel product.

There are two prior patents related to the application of the hypochlorous acid gel to antibiosis: CN102596207 disclosing a hydrogel formulation for administration of drugs; CN103796515 disclosing sodium bicarbonate added in an electrolysis process for production of hypochlorous acids. In each of the above two prior patents, a product prepared is preserved as gels, which are squeezed out and applied on a surface to be disinfected by hands or another medium rather than from a sprayer, and criticized for higher infection and contamination risks during topical administration.

In view of the above situations, the hypochlorous acid gel for disinfection which is restricted in specific applications needs to be corrected for lower infection and contamination risks.

### SUMMARY OF THE INVENTION

A hypochlorous acid composition and applications thereof are explained hereinafter through test data in example comparisons and embodiments for clear understanding of technical features, content, advantages, and efficiency by patent examiners.

For clear descriptions of differences in example comparisons and embodiments of the present disclosure, the sterilization effect of a hypochlorous acid composition is indicated by free available chlorine (FAC) which denotes a concentration of chlorine in a hypochlorous acid composition.

For that matter, a person with general knowledge in the art is conscious of the fact that the higher content of FAC contributes to the better sterilization effect of a substance.

In the tests of the present disclosure, the content of FAC, which is represented by ppm (parts per million), in a hypochlorous acid composition stored for a long period of time is compared with the initial content of FAC in a hypochlorous acid composition and the ratio of both FACs is indicated as percentage (%).

A thermal ageing test in the present disclosure is aimed at checking stabilities of hypochlorous acid gels made of different compositions and stored for a long period of time in a high-temperature environment through which an environment for long-term storage at room temperature is simulated.

In the thermal ageing test in the present disclosure, a determinand is carried in a glass bottle witch is sealed by a PP (polypropylene) cap and stored in an oven for a 14-day test at 54° C. based on test parameters to simulate storage status at room-temperature for one year and check the stability of hypochlorous acid gels.

The viscosity of hypochlorous acid gels is measured by a viscosity meter (HVDV-II+ manufactured by Brookfield) equipped with a probe (LV1 or RV1) in the test. The viscosity meter is operated in a beaker in which 400 ml test liquids are carried (test conditions: 1 rpm; room temperature) for measuring viscosities of different compositions or gels.

### DETAILED DESCRIPTION OF THE INVENTION

### Embodiment 1: Method to Prepare a Hypochlorous Acid Composition

Reagents required:

| | |
|---|---|
| Sodium magnesium fluorosilicate | 3 wt % |
| HClO solution | 94.12 wt % |
| 1M hydrochloric acid (HCl) | 2.88 wt % |
| solution | |

Steps to prepare a hypochlorous acid composition:

S101: Add sodium magnesium fluorosilicate into the HC1O solution (25° C.) gradually for preparation of a precursor solution;

S102: Stir the precursor solution for at least 30 minutes until no powder or lump is observed;

S103: Check production of a translucent gelatinous liquid and add HC1;

S104: Stir the mixed solution until its viscosity ranges from 100 to 1800 cp and leave the solution to stand for a pH value stabilized.

A final hypochlorous acid composition includes ingredients shown as follows:

| Sodium magnesium fluorosilicate | 3 wt % |
|---|---|
| Hypochlorous acid | 0.02 wt % |
| Water | 96.812 wt % |
| Other | 0.168% |

In the above table, “other” refers to by-products derived from Step S101 to Step S104, for example, sodium chloride.

### Embodiment 2: Application of a Hypochlorous Acid Composition

The reagent is the hypochlorous acid composition prepared in Embodiment 1.

Steps for the application of the hypochlorous acid composition are shown as follows:

S201: Spray the hypochlorous acid composition prepared in Embodiment 1 from a sprayer;

S202: Hypochlorous acid gels with the viscosity ranging from 6,400 to 17,000 cp form after the hypochlorous acid composition is sprayed.

### Embodiment 3: Comparisons of Stabilities for Hypochlorous Acid Gels

The stabilities of the sodium magnesium fluorosilicate, i.e., the raw material of hypochlorous acid gels in the patent application, and silicate, i.e., the raw material of other hypochlorous acid gels commercially available, are compared.

Hypochlorous acid gels are prepared with sodium magnesium fluorosilicate and silicate commercially available, respectively; the hypochlorous acid gels are carried in glass bottles sealed by PP caps for a 14-day thermal ageing test at 54° C. , respectively. Then, the properties such as pH value and content of FAC of two types of hypochlorous acid gels are checked and shown in Table 1. According to test results, sodium magnesium fluorosilicate used in the patent application contributes to better pH and stability of the hypochlorous acid than silicate commercially available.

TABLE 1
Thermal ageing test for sodium magnesium fluorosilicate and silicate

| | Content | | | | |
|---|---|---|---|---|---|
| | of FAC | | | | |
| | (ppm) | | Preservation | pH | |
| | | 14 | of FAC | | 14 |
| Sample | 0 | days | (%) | 0 | days |
| Sodium magnesium fluorosilicate | 170 | 117 | 68.8% | 5.72 | 6.6 |
| (patent application) | | | | | |
| Silicate (commercially available) | 171 | 91 | 53.20% | 7.18 | 7.21 |

### Embodiment 4: Comparisons of Stabilities for Hypochlorous Acid Gels Prepared With Sodium Magnesium Fluorosilicates Having Specific Ingredient Proportions

Hypochlorous acid gels are prepared with sodium magnesium fluorosilicates having specific ingredient proportions, respectively; the hypochlorous acid gels are carried in glass bottles sealed by PP caps for a 14-day thermal ageing test at 54° C. , respectively. Then, the properties such as pH value, content of FAC and adhesion of hypochlorous acid gels sprayed are compared and shown in Table 2. According to test results such as stability, comprehensive stability, pH value, and adhesion of hypochlorous acid gels sprayed, the sodium magnesium fluorosilicate with the concentration of 2.50 wt % performs better than another sodium magnesium fluorosilicate.

TABLE 2
Thermal ageing test for sodium magnesium fluorosilicates with
specific ingredient proportions in prepared hypochlorous acid gels

| Sample | | | | | | |
|---|---|---|---|---|---|---|
| Sodium | Content of | | | | | |
| magnesium | FAC (ppm) | | Preservation | pH | | |
| fluorosilicate | 0 | 14 days | of FAC (%) | 0 | 14 days | Adhesion |
| 2.50 wt % | 241 | 163 | 67.60 | 6.27 | 6.43 | Adhesion |
| | | | | | | on arms |
| 3.00 wt % | 241 | 155 | 64.50 | 6.41 | 6.58 | Adhesion |
| | | | | | | on arms |

### Embodiment 5: Test for Ageing Stability of Hypochlorous Acid Gels

Hypochlorous acid gels are sealed in a PET (polyethylene terephthalate) bottle on which a nozzle is installed for a 14-day thermal ageing test at 54° C. Then, the properties such as pH value and content of FAC are checked and shown in Table 3. According to test results, it can be estimated that the ageing-related parameters, such as stability of hypochlorous acid and pH value, of prepared hypochlorous acid gels which had been stored for one year at room temperature are satisfactory.

TABLE 3
Thermal ageing test of hypochlorous acid gels

| | Content of | | Preservation | | |
|---|---|---|---|---|---|
| | FAC (ppm) | | of FAC | pH | |
| Sample | 0 | 14 days | (%) | 0 | 14 days |
| Hypochlorous | 241 | 137.27 | 56.50 | 6.27 | 6.4 |
| acid gel | | | | | |

### Embodiment 6: Stability of High-Concentration Hypochlorous Acid Gels in a Thermal Ageing Test

As shown in test results in Table 4, stability of high-concentration hypochlorous acid gels prepared herein is satisfactory.

TABLE 4
High-concentration hypochlorous acid gels in a thermal ageing test

| | Content of | | Preservation | | |
|---|---|---|---|---|---|
| | FAC (ppm) | | of FAC | pH | |
| Sample | 0 | 14 days | (%) | 0 | 14 days |
| High-concentration | 400 | 202 | 50.5% | 6.35 | 6.63 |
| Medium-concentration | 330 | 197 | 59.6% | 6.45 | 6.50 |
| Low-concentration | 265 | 170.7 | 64.4% | 6.41 | 6.58 |

### Embodiment 7: Change in Viscosity of Hypochlorous Acid Gels Before and After Spraying

Stored as a liquid, the hypochlorous acid composition in the present disclosure is transformed to gelatinous substances and covers a surface to be disinfected for lower contamination and infection risks while sprayed from a nozzle without another medium. Accordingly, the change in viscosity of the hypochlorous acid composition before and after spraying should be checked. As shown in Table 5, the viscosity of prepared hypochlorous acid gels which have been sprayed increases significantly and is 2.8 times higher than the original viscosity. Moreover, the hypochlorous acid composition stored as a liquid doesn't adhere to a vertical surface in the beginning but is sprayed and transformed to hypochlorous acid gels which adhere to a vertical surface.

TABLE 5
Change in viscosity of a hypochiorous acid composition
before and after spraying

| Sample | Viscosity (cp) | Increase (%) |
|---|---|---|
| Before spraying | 2880 | |
| After spraying | 8040 | 279.1% |

### Embodiment 8: Changes in Viscosities of Hypochlorous Acid Gels Prepared With Sodium Magnesium Fluorosilicates Having Specific Ingredient Proportions

As shown in Table 6, the viscosities of prepared hypochlorous acid gels which have been sprayed increase significantly, for example, the viscosity of hypochlorous acid gels prepared with 3.00 wt % sodium magnesium fluorosilicate is 9.3 times higher than the hypochlorous acid composition not sprayed.

TABLE 6
Change in viscosity of a hypochlorous acid composition prepared
with sodium magnesium fluorosilicate having a specific ingredient
proportion before and after spraying

| | Viscosity (cp) | | |
|---|---|---|---|
| | Before | After | Increase |
| Sample | spraying | spraying | (%) |
| 2.50 wt % sodium magnesium | 1664 | 11264 | 676.9 |
| fluorosilicate | | | |
| 3.00 wt % sodium magnesium | 1536 | 14336 | 933.3 |
| fluorosilicate | | | |

### Example Comparison 1: Comparisons of Stabilities Between the Hypochlorous Acid Composition in the Present Disclosure and Another Hypochlorous Acid Gel Product 1

The preservation of FAC for hypochlorous acid gels prepared in the present disclosure and another hypochlorous acid gel product 1 is checked in a 14-day thermal ageing test at 54° C. In this regard, the hypochlorous acid gel product 1 refers to higher-viscosity gels; the hypochlorous acid gels in the present disclosure form through a nozzle after squeezing for less contact pollution and no jam at a nozzle. As shown in Table 7 for a thermal ageing test, the preservation of FAC of a hypochlorous acid composition is 68.8% which means better stability than another hypochlorous acid gel product 1 with the preservation of FAC of 53.2%.

TABLE 7
Comparing the hypochlorous acid composition in the present
disclosure with another hypochlorous acid gel product 1 in a
thermal ageing test

| | Preservation |
|---|---|
| Sample | of FAC (%) |
| Hypochlorous acid composition in the | 68.8% |
| present disclosure | |
| Another hypochlorous acid gel product 1 | 53.2% |

### Example Comparison 2: Comparisons of Stabilities Between the Hypochlorous Acid Composition in the Present Disclosure and Another Hypochlorous Acid Gel Product 2

The stabilities between the hypochlorous acid composition in the present disclosure and another hypochlorous acid gel product 2 are compared wherein the hypochlorous acid composition in the present disclosure and another hypochlorous acid gel product 2 are carried in glass bottles sealed by PP caps for a 14-day thermal ageing test at 54° C. , respectively. Then, the properties such as pH value and content of FAC are checked. As shown in Table 8, the stability of the hypochlorous acid composition in the present disclosure is better than that of another hypochlorous acid gel product 2.

TABLE 8
Comparing the hypochlorous acid composition in the present
disclosure with another hypochlorous acid gel product 2

| | Content of | | Preservation | | |
|---|---|---|---|---|---|
| | FAC (ppm) | | of FAC | pH | |
| Sample | 0 | 14 days | (%) | 0 | 14 days |
| Hypochlorous acid composition | 170 | 117 | 68.8% | 5.72 | 6.6 |
| in the present disclosure | | | | | |
| Another hypochlorous acid gel | 177 | 102 | 57.6% | 6.49 | 6.69 |
| product 2 | | | | | |

### Example Comparison 3: Comparisons Between Hypochlorous Acid Gels Prepared With Different Strong Acids

The hypochlorous acid gels prepared with sulfuric acids as acid agents are carried in a glass bottle sealed by a PP cap for a 14-day thermal ageing test at 54° C. after which the properties such as pH value, content of FAC and adhesion are checked.

As shown in Table 9, hypochlorous acid gels prepared with sulfuric acids as acid agents have analogous properties such as quality, pH value and comparability of hypochlorous acid, all of which are comparable to properties of gels prepared with hydrochloric acids in the past.

TABLE 9
Comparisons of stabilities between the hypochlorous
acid composition in the present disclosure and
another hypochlorous acid gel product 1

| | Content of FAC (ppm) | | | pH | | | |
|---|---|---|---|---|---|---|---|
| | | After | Residual | | After | | |
| | | 14 days | content | | 14 days | Before | After |
| | 0 | at 54° C. | (%) | 0 | at 54° C. | spraying | spraying |
| Preparation | 258 | 182 | 70.4% | 6.27 | 6.40 | No adhesion | Adhesion |
| based | | | | | | to arms | to arms |
| on H₂SO₄ | | | | | | | |
| Preparation | 265 | 179 | 67.6% | 6.27 | 6.43 | No adhesion | Adhesion |
| based | | | | | | to arms | to arms |
| on HCl | | | | | | | |

A hypochlorous acid composition and applications thereof have been described and explained in test results of the present disclosure wherein hypochlorous acid gels are created from a sprayed hypochlorous acid composition and evenly coated on an object without another medium for lower infection and contamination risks and further applications of hypochlorous acids to sterilization and cleaning in service.

The above detailed descriptions are preferable embodiments of a hypochlorous acid composition only that should not restrict the scope of the present application in practice; any modification or equivalent replacement without departing from the spirit and scope of the present application should be incorporated in claims hereinafter.

What is claimed is:

1. A hypochlorous acid composition, comprising:
fluorosilicate with a concentration ranging from 2.00 to 3.50 wt %; and
free available chlorine (FAC) with a concentration ranging from 10 to 500 ppm;
wherein the free available chlorine (FAC) comprises hypochlorous acid and hypochlorite.

2. The hypochlorous acid composition as claimed in claim 1 wherein the hypochlorous acid composition has a viscosity ranging from 1 to 2000 cp.

3. The hypochlorous acid composition as claimed in claim 1 wherein the hypochlorous acid composition has a pH value ranging from 5.0 to 8.0.

4. The hypochlorous acid composition as claimed in claim 1 wherein the hypochlorous acid composition has a pH value ranging from 6.0 to 7.0.

5. The hypochlorous acid composition as claimed in claim 1 wherein the fluorosilicate is sodium magnesium fluorosilicate or sodium magnesium lithium fluorosilicate.

6. A method for producing hypochlorous acid gels:
the hypochlorous acid composition as claimed in claim 1 is carried in and sprayed from a sprayer; and
the hypochlorous acid composition sprayed is transformed to the hypochlorous acid gels.

7. The method for producing hypochlorous acid gels as claimed in claim 6 wherein the hypochlorous acid gels features a viscosity ranging from 6000 to 20000cp.

8. The method for producing hypochlorous acid gels as claimed in claim 6 wherein the hypochlorous acid gels features a viscosity ranging from 8000 to 15000 cp when a viscosity meter is operated at 1 rpm.
